(19) United States
(12) Patent Application Publication
(10) Pub. No.: US 2013/0304315 A1
(43) Pub. Date: Nov. 14, 2013

(54) OPERATOR RECOGNITION SYSTEM

(71) Applicants: Svetoslav Georgiev Stoyanov, Lawrenceville, GA (US); James Pettis, Duluth, GA (US)

(72) Inventors: Svetoslav Georgiev Stoyanov, Lawrenceville, GA (US); James Pettis, Duluth, GA (US)

(73) Assignee: Elesys North America Inc., Suwanee, GA (US)

(21) Appl. No.: 13/468,844

(22) Filed: May 10, 2012

(51) Int. Cl. G06F 7/00

(52) U.S. Cl. 701/36; 701/1

(57) ABSTRACT

A vehicular control system includes a transmitter electrode. The system also includes a receiver electrode for an input device. A control unit is in communication with the transmitter electrode and the receiver electrode. The control unit is operable to determine that an input is received at the input device, and provide a transmit signal to the transmitter electrode. The control unit is also operable to detect a receive signal arising from the transmit signal at the receiver electrode, and determine which of a passenger in a passenger seat or a driver in a driver seat caused the input.

### TECHNICAL FIELD

This disclosure relates to systems and methods (generally referred to as systems) for passenger recognition as it relates to interaction of the passenger with the vehicle. More specifically, this disclosure relates to a system for enabling a passenger to control electronics in a vehicle.

### BACKGROUND

Rapid improvements in technology have led to vehicles with a vast array of electronic systems, ranging from climate control to global positioning systems (“GPS”) and digital versatile disc (“DVD”) players. Consumer demand for vehicles with electronic systems may be increased by making the systems less complicated and more convenient to control and operate.

### BRIEF DESCRIPTION OF THE DRAWINGS

The innovation may be better understood with reference to the following drawings and description. In the figures, like reference numerals designate corresponding parts throughout the different views.

FIG. 1 is a block diagram of an exemplary passenger compartment.

FIG. 2 is a block diagram of exemplary components in a passenger compartment.

FIG. 3 is a block diagram of exemplary components in a passenger compartment.

FIG. 4 is a perspective view of an exemplary passenger seat in a passenger compartment.

FIG. 5 is a perspective view of an exemplary passenger seat in a passenger compartment.

FIG. 6 is a top view of an exemplary passenger seat in a passenger compartment.

FIG. 7 is a flow diagram of an exemplary method of recognizing a passenger.

FIG. 8 is a flow diagram of an exemplary method of recognizing a passenger.

FIG. 9 is a flow diagram of an exemplary method of recognizing a passenger.

FIG. 10 is a flow diagram of an exemplary method of recognizing a passenger.

### DETAILED DESCRIPTION

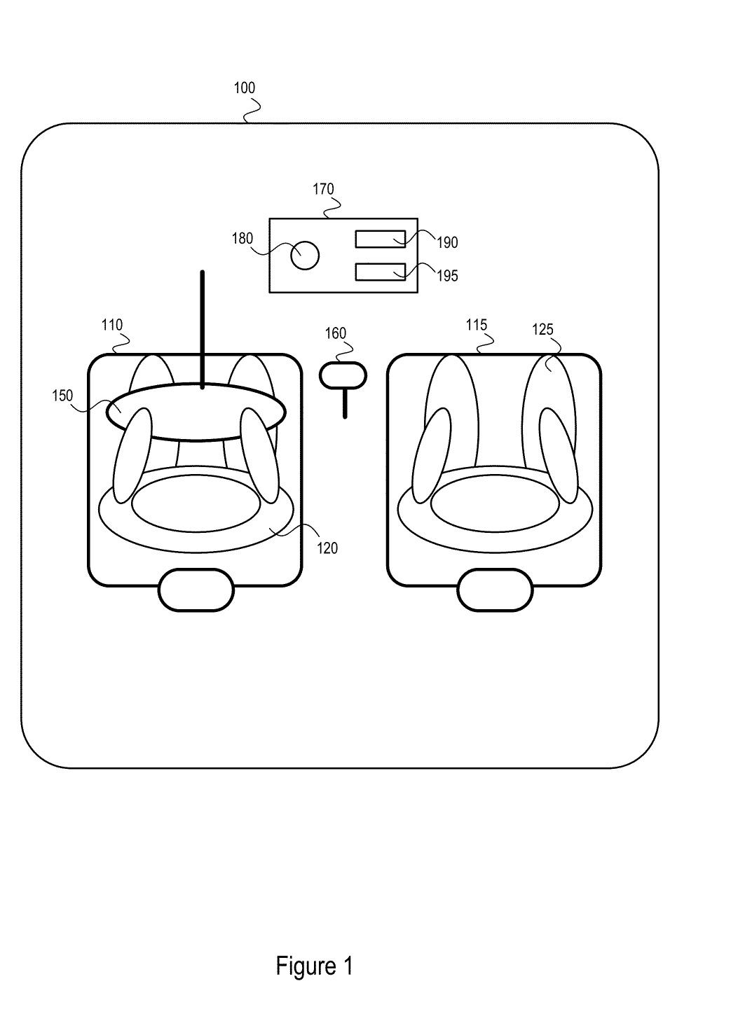

FIG. 1 is a block diagram of an example passenger compartment 100. The passenger compartment 100 may include one or more components, such as a driver seat 110, a passenger seat 115, a steering wheel 150, a gear adjuster 160, and a dashboard control 170. The passenger compartment 100 may include additional, fewer, or different components, such as electronic seat adjustment controls and rear view or side view mirror controls.

The passenger compartment 100 may be that of an automobile or other vehicle capable of ground travel, such as a car, truck, van, mobile home, construction equipment, or other road or off-road vehicle. The passenger compartment 100 may also or alternatively be part of a boat, ship, or other vessel or vehicle capable of travel by water. The passenger compartment 100 may also be in a helicopter, plane, or other flying vehicle. While a specific example is given below, the passenger compartment 100 need not include the vehicle directional or speed controls (e.g., the steering wheel, accelerator pedal, and brake pedal), but may instead represent any area in which a vehicle passenger may travel.

The passenger compartment 100 may include a driver seat 110. The driver seat 110 may be or may represent a seat in which a person, user, operator or controller of a movement of the passenger compartment 100, such as the driver 120, may be positioned. The driver 120 may control one or more operations of the passenger compartment 100, such as a movement of the passenger compartment 100 (or vehicle). A driver side of the passenger compartment 100 may refer to a portion of the passenger compartment 100 that is occupied by or surrounds a driver 120, or is adjacent to the driver seat 110.

The passenger compartment 100 may also or alternatively include a passenger seat 115. The passenger seat 115 may represent a seat in which a person, passenger or user that is not controlling a movement of the passenger compartment 100, such as passenger 125, may be positioned. A passenger side of the passenger compartment 100 may refer to a portion of the passenger compartment 100 that is occupied or surrounds the passenger 125, or is adjacent to or includes the passenger seat 115. While the passenger compartment 100 is shown with one driver seat 110 and one passenger seat 115, other vehicles may include more than one driver seat 110 or more than one passenger seat 115.

The passenger compartment 100 may include one or more input devices, interfaces, controls or control modules (generally referred to as “input devices”). Input devices may be configured to receive an input from an operator, such as a driver 120 or passenger 125, and perform a function.

Some input devices may control a movement or mode of operation of a passenger compartment 100. For example, the passenger compartment 100 may include a steering wheel 150. The driver 120 may operate, control, or manipulate the steering wheel 150 to control a movement of the passenger compartment 100. Another input device that may control a movement of the passenger compartment 100 may be a shift or gear adjuster 160. The gear adjuster 160 may be used to control movement of the passenger compartment 100. For example, where the passenger compartment 100 is part of a car, the gear adjuster 160 may control a mode of operation of the car and may be toggled between one or more of a “Park” mode, a “Reverse” mode, a “Drive” mode, an “Overdrive” mode, a “Low Gear” mode, or various other modes. The gear adjuster 160 may additionally or alternatively operate as a stick shift in some passenger compartments 100, and may be used to change a mode of operation of a vehicle between gears, such as between a first gear to a second gear. The gear adjuster 160 may additionally or alternatively include a toggle or switch which may activate a four-wheel drive or all-wheel drive mode of operation of the passenger compartment 100. The driver 120 may manipulate the gear adjuster 160 to control a gear or mode of operation of a vehicle.

Another input device that may control a movement of the passenger compartment 100 may be or include an acceleration or power control (e.g., a foot gas pedal), which may control an amount of thrust, acceleration, or power to propel the passenger compartment 100 in a forward or reverse direction. The passenger compartment 100 may also or alternatively include a brake or stop pedal, which may control a stopping mechanism to stop movement of a vehicle. The driver 120 may operate a power control to control a movement of the passenger compartment 100. The passenger compartment 100 may additionally or alternatively include one or more input devices, interfaces, controls, or control modules which may control supplemental functions that may not be related to controlling a movement of the passenger compartment 100. For example, a passenger compartment 100 may include a dashboard control unit or module, such as dashboard control 170. Input devices controlling supplemental functions of a passenger compartment 100 not related to movement are referred to as dashboard controls 170, though various other input devices and locations are possible.

The dashboard control 170 may be configured to receive an input from an operator (such as a driver 120 or a passenger 125) in various ways. The dashboard control 170 may, for example, include one or more knobs 180 or buttons 190 and 195 through which an operator may provide an input to the dashboard control 170. The dashboard control 170 may additionally or alternatively include a touch screen which may be manipulated through a touch from an operator, pen, or other pointing device to provide an input to the dashboard control 170. The dashboard control 170 may perform one or more functions in response to the input.

An example of a supplemental function that may be controlled by a dashboard control 170 may include a temperature function in a vehicle, such as a temperature control for a passenger side of the passenger compartment 100, or a temperature control for a driver side of the passenger compartment 100. Another example of supplemental functions that may be controlled by a dashboard control 170 may include functions related to an operation of an entertainment system in a vehicle, such as an adjustment of a volume of an audio from the entertainment system, a selection of a playback function of the entertainment system, a selection or identification of a source of an entertainment to be played using the entertainment system, or a control of one or more audio or visual features of an entertainment system. Various other examples of supplemental functions that may be controlled by a dashboard control 170 are possible, including functions related to an operation of a garage door, a cigarette lighter, a power-window, a defroster, a heater, an air conditioner, a windshield wiper, a sunroof, a moonroof, lights or lighting, a horn, a radio, an optical disc player such as a compact-disc player or digital versatile disc player, a livewell, a depth finder, a global positioning system (“GPS”), or various other electronics or devices.

One or more of the components of the vehicle, such as the steering wheel 150, the gear adjuster 160, or the dashboard controls 170, may include or may be in communication with separate controllers. As an example, the dashboard control 170 may include a dashboard controller that may receive and interpret an input to the dashboard control 170 and control an operation and functions of the dashboard control 170 in response to the input. For example, the dashboard controller may receive an input to adjust a volume of the entertainment system, and may instruct the speakers to adjust a volume of output in accordance with the received input. The controllers of the components of the passenger compartment 100 may be connected with and communicate through a vehicle communication bus.

The components of the passenger compartment 100 may be positioned in various ways and configurations. For example, while the passenger seat 115 is shown as being positioned to the right of the driver seat 110, in other vehicles, the placement of the driver seat 110 and passenger seat 115 may be reversed, or the passenger seat 115 may be placed in various other positions. As another example, in some passenger compartments 100, the gear adjuster 160 may be included near or adjacent to the steering wheel 150. In some passenger compartments 100, dashboard controls 170 may be located on a console between the driver seat 110 and the passenger seat 115, or in various other locations. In some vehicles, multiple dashboard controls 170 controlling supplemental functions unrelated to controlling a movement of the passenger compartment 100 may be included in the passenger compartment 100, such as in or with the steering wheel 150, along an interior side of the passenger compartment 100, or attached to an interior roof of the passenger compartment 100. Various other variations are possible.

The passenger compartment 100 may intelligently control which components in the passenger compartment 100 any given operator may provide an input to, and which components may be operable by both the driver 120 and the passenger 125. In some passenger compartments 100, functions of input devices may be classified as permitted functions or non-permitted functions. A permitted function may be initiated by an input from either a driver 120 or a passenger 125. A non-permitted function may be initiated by an input from only one of the driver 120 or the passenger 125.

The distinction between a permitted function and a non-permitted function may be based on whether a function causes movement of the passenger component 100. For example, a non-permitted function, such as operation of a gear adjuster 160, may be initiated by an input from the driver 120, but not from an input from the passenger 125. The passenger compartment 100 may restrict a passenger 125 from performing these functions while allowing a driver 120 to perform these functions.

The distinction between a permitted function and a non-permitted function may be based on functions that may cause distractions to a driver 120. For example, a non-permitted function, such as operation of a dashboard control 170, may be initiated by an input from the passenger 125, but not from an input from the driver 120. The passenger compartment 100 may restrict a driver 120 from performing these functions while allowing a passenger 125 to perform the functions. In other systems, the distinction between a permitted function and a non-permitted function may be based on each input device, or set in various other ways.

Additionally or alternatively, the passenger compartment 100 may intelligently apply an input from a driver 120 at an input device to perform some functions, while applying an input from a passenger 125 at the same input device to perform a different function. For example, the passenger compartment 100 may recognize an operator that inputs a temperature adjustment to a dashboard control 170, and may adjust a temperature for the operator-side of the passenger compartment 100 accordingly. In these and other situations, it may be useful or beneficial to control one or more components in a passenger compartment 100 to respond or perform one or more functions in response to an identification of an operator.

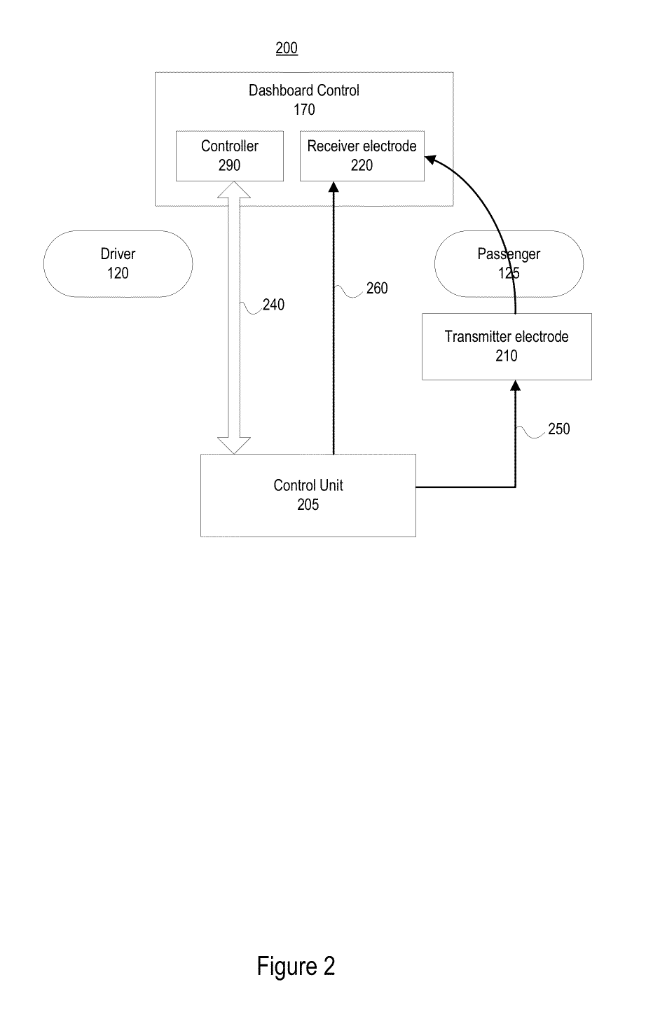

FIG. 2 is a block diagram of an example operator recognition system 200 that may be included in and used with a passenger compartment 100. The operator recognition system 200 may include one or more components of a passenger compartment 100, such as one or more dashboard controls 170. The operator recognition system 200 may control the components of the passenger compartment 100 to operate, react, or perform a function according to or based on an operator that interacts with the components. The operator recognition system 200 may leverage an intrabody current signal to determine which operator is contacting or manipulating a component or control of a passenger compartment 100.

The operator recognition system 200 may include one or more of a dashboard control 170, a control unit 205, a transmitter electrode 210, a receiver electrode 220, and a vehicle communication bus 240.

The transmitter electrode 210 may be a capacitor, resistor, electrical conductor, or a combination of electrical components such as capacitors and resistors. For example, the transmitter electrode 210 may be a copper foil sheet of various shapes or sizes. The transmitter electrode 210 may be positioned within, manufactured or constructed as part of, or otherwise attached to the passenger seat 115.

The control unit 205 may communicate with the transmitter electrode 210. The control unit 205 may be configured to transmit, send, provide to, or otherwise communicate a transmit signal, voltage, or current to the transmitter electrode 210. As an example, the control unit 205 may send a pulsed transmit signal to the transmitter electrode 210. The pulsed transmit signal may be sent periodically, at selected times, continuously, or when triggered, such as when a control unit 205 determines that an input has been received at the dashboard control 170.

A pulsed signal sent by the control unit 205 may have various frequencies, amplitudes, and duty cycles. For example, the pulsed transmit signal may be about a 3.88 kHz pulse with 5 V amplitude and a 50% duty cycle. In some systems, the frequency of the pulsed signal may be set based on a time needed by a control unit 205 to receive an input signal from the controller 290, convert the received signal from an analog signal to a digital signal, and take a measurement at the receiver electrode 220. Setting a pulse frequency in this manner may allow for an adequate amount of time to charge or discharge the transmitter electrode 210 when generating a signal. This may additionally or alternatively allow for an adequate amount of time to perform an analog-to-digital signal conversion at the receiver electrode 220. Other variations are possible.

Signals, such as a pulsed transmit signal, may be sent by the control unit 205 to the transmitter electrode 210 along one or more wired or wireless communication links or lines, such as along the communication line 250. The communication line 250 may be a shielded wire. In some systems, the communication line 250 may be an electrically wiring or coupling between the interface 380 of the control module 205 and a portion of the transmitter electrode 210. Other variations are possible. The dashboard control 170 may include one or more of a receiver electrode 220 and a controller 290. The controller 290 of the dashboard control 170 may receive an input from one or more input modules, buttons, knobs, or sliders of the dashboard control 170. The controller 290 may perform, or instruct a subsystem of the passenger compartment 100 to perform, one or more functions in response to a received input.

The controller 290 of the dashboard control 170 may be configured to connect to one or more other components of the passenger compartment 100 in various ways, such as by or through the vehicle communication bus 240. The vehicle communication bus 240 may be connected with or used to communication between one or more components of the passenger compartment 100, such as the steering wheel 150, the gear adjuster 160, the dashboard control 170, and the control unit 205. The control unit 205 may be configured to communicate commands or signals between one or more components of the passenger compartment 100 through the vehicle communication bus 240.

The control unit 205 may be in communication with the controller 290 of the dashboard control 170, such as through the vehicle communication bus 240. The control unit 205 may be configured to monitor and receive inputs from the dashboard control 170 through the vehicle communication bus 240. The controller 290 may provide the control unit 205 with information and data about inputs and status changes for the dashboard controls 170. The controller 290 may alert the control unit 205 when an input is received at the dashboard control 170, such as through the vehicle communication bus 240.

The dashboard control 170 may additionally or alternatively include a receiver electrode 220. The receiver electrode 220 may be a capacitor, resistor, electrical conductor, or a combination of electrical components such as capacitors and resistors. For example, the transmitter electrode 210 may be a copper foil sheet of various shapes or sizes. The receiver electrode 220 may be positioned with, constructed as part of, or otherwise attached to one or more components of the passenger compartment 100. For example, the receiver electrode 220 may be positioned behind, and in communication with, a surface, button, knob, or other interface of a dashboard control or other dashboard control 170. The receiver electrode 220 may be connected with and cover one or more controls, inputs, buttons, or modules that the operator recognition system 200 may be operable to control a function of or limit access to.

In some systems, a receiver electrode 220 may be implemented for each button or knob on a dashboard control 170 that the system 200 will control. In some systems, one receiver electrode 220 may be implemented for each dashboard control 170. The receiver electrode 220 may alternatively or additionally be connected to, included as part of, or in communication with various other components of the passenger compartment 100, such as the steering wheel 150 or gear adjuster 160.

The control unit 205 may be configured to monitor, receive, or otherwise detect a signal or current, such as a receive signal, received at or provided by the receiver electrode 220. Signals or current may be received by the control unit 205 from the receiver electrode 220 along one or more wired or wireless communication links or lines, such as along the communication line 260. In some systems, the communication line 260 may be an electrically wiring or coupling between the interface 385 of the control module 205 and a portion of the receiver electrode 220. The operator recognition system 200 may be configured to identify an operator that interacts with a component of the passenger compartment 100 and provide a response based on the operator. The control unit 205 may receive an input, or an indication of an input, from the dashboard control 170, such as through the vehicle communication bus 240, through a wired or wireless connection, or in various other ways. For example, the control unit 205 may receive an input, such as a press of a button or turn of a knob, on a dashboard control through the vehicle communication bus 240.

Whenever desired (e.g., before, simultaneously with, or when triggered by receiving the input from the dashboard control 170), the control unit 205 may send, transmit, or otherwise provide a signal or current, such as the pulsed signal, to the transmitter electrode 210. The control unit 205 may transmit the transmit signal or current to the transmitter electrode 210 continuously, periodically, at intervals, when triggered, randomly, or at various other times. For example, the control unit 205 may send or transmit the transmit signal or current to the transmitter electrode 210 when, or as soon as, the control unit 205 receives an indication from the controller 290 that an input has been initiated at the dashboard control 170. In some of these systems, the signal or current may be received by the transmitter electrode 210 and transmitted by a passenger 125 to the receiver electrode 220 while the passenger 125 is still providing the input to the dashboard control 170. Additionally or alternatively, in some systems, the control unit 205 may transmit a signal or current continuously, or at high frequency intervals. Various other timings and variations in sending the signal or current to the transmitter electrode 210 are possible. A passenger 125 that is positioned in the passenger seat 115 may receive the current or signal from the transmitter electrode 210. The passenger 125 may receive the current or signal directly, such as where the passenger 125 directly contacts the transmitter electrode 210. The passenger 125 may alternatively receive the current or signal indirectly, such as where one or more layers of clothing, padding, foam, cloth, seat coverings, or other material exists between the passenger 125 and the transmitter electrode 210.

The control unit 205 may monitor the receiver electrode 220 in communication with the dashboard control 170. When the input is provided to the dashboard control 170 through a contact initiated by a passenger 125 in contact with the transmitter electrode 210, the transmit signal provided to the transmitter electrode 210 by the control unit 205 may be transmitted, or may cause a receive signal to be transmitted, to the receiver electrode 220 through the passenger 125. At this point, the transmitter electrode 210 and the receiver electrode 220 may be capacitively coupled through the passenger 125.

The control unit 205 may receive or detect the receive signal at the receiver electrode 220 through the communication line 260 contemporaneously with or nearly at the same time as the detection of the input at the dashboard control 170. The receive signal may arise from, may be, or may be based on, the transmit signal that was provided to the transmitter electrode 220.

In contrast, when the input is provided to the dashboard control 170 by a contact initiated by a driver 120, or a passenger 125 that is not in contact with the transmitter electrode 210, no signal may be transmitted to the receiver electrode 220 through the driver 120 or other passenger 125. For example, a driver 120 seated in a driver seat 110 without any transmitter electrode 210 may not transmit any signal to the receiver electrode 220 when the driver 120 interacts with the receiver electrode 220.

The control unit 205 may determine or recognize the operator that provided the input to the dashboard control 170 (or other component of the passenger compartment 100) by monitoring the receiver electrode 220 connected with the dashboard control 170. When the control unit 205 detects a receive signal at the receiver electrode 220 contemporaneously with or shortly before or after detection of the input at the dashboard control 170, the control unit 205 may determine the input as having been provided by a passenger 125 in contact with the transmitter electrode 210. Alternatively, when the control unit 205 does not detect a receive signal at the receiver electrode 220 contemporaneously with or shortly before or after receipt or detection of the input at the dashboard control 170, the control unit 205 may determine the input as having been provided by a driver 120.

In some systems, the control unit 205 may compare a detected receive signal at the receiver electrode 220 with a threshold value to determine, interpret, or recognize the inputting operator. The control unit 205 may determine an input as being provided by the passenger 125 in contact or communication with the transmitter electrode 210 when the detected receive signal that is greater than the threshold value. The control unit 205 may determine the input as being provided by a driver 120 when the detected receive signal is not greater than the threshold value. The threshold value may be set to reduce a minor or incidental signal or current that is not indicative of the transmit signal provided to the transmitter electrode 210. The threshold value may be set or programmed above a noise level to avoid potentially faulty readings. As an example, the threshold value may be 50% of the pulsed transmit signal amplitude. The threshold value may be set, programmed, or updated automatically or manually. Other variations are possible. The control unit 205 may send one pulse to the transmitter electrode 210 when an input is detected, and may measure a detected response at the receiver electrode 220 to determine if the input was provided by a passenger 125 or a driver 120. Alternatively, the control unit 205 may send multiple pulses to the transmitter electrode 210. For example, the control unit 205 may send many pulses (such as, for example, 254 pulses) to the transmitter electrode 210 in succession or in a short time when an input is detected. The pulses may be sent in accordance with a pulse frequency, such as around 3.88 KHz. The control unit 205 may detect a response at the receiver electrode 220 for the pulses.

The control unit 205 may implement one or more algorithms or procedures associated with sending multiple pulses to determine when an input is provided by a passenger 125 or a driver 120. For example, the control unit 205 may not consider an input to be provided by a passenger 125 unless the control unit 205 detects a signal at the receiver electrode 220 corresponding to more than 10% (or any other ratio) of the pulses sent to the transmitter electrode 210. In this way, a control unit 205 may react to or require a repeatable outcome positively indicating that an input was provided by a passenger 125, and may not incorrectly interpret a false-positive signal that was received in a similar time period as the transmit signal as indicative of an input provided by a passenger 125. Other variations are possible.

The recognition of the operator may be performed through the use of one passenger transmitter electrode 210, the receiver electrode 220, and the control unit 205. The determination of the operator that provides the input to the dashboard control 170 may be performed without any electrode being needed or used with a driver seat 110.

The control unit 205 may provide a signal, command, or instruction to the controller 290 of the dashboard control 170 in response to the input, which may be used to control an operation of the dashboard control 170. The instruction provided may be based on the recognition of the operator that provides the input to the dashboard control 170. The control unit 205 may instruct the dashboard control 170 to provide different interfaces and functionality based on the recognition of the operator that provides an input to the dashboard control 170. The control unit 205 may disable or enable functionality of a dashboard control 170 based on the determination or recognition of the operator that provides the input to the dashboard control 170.

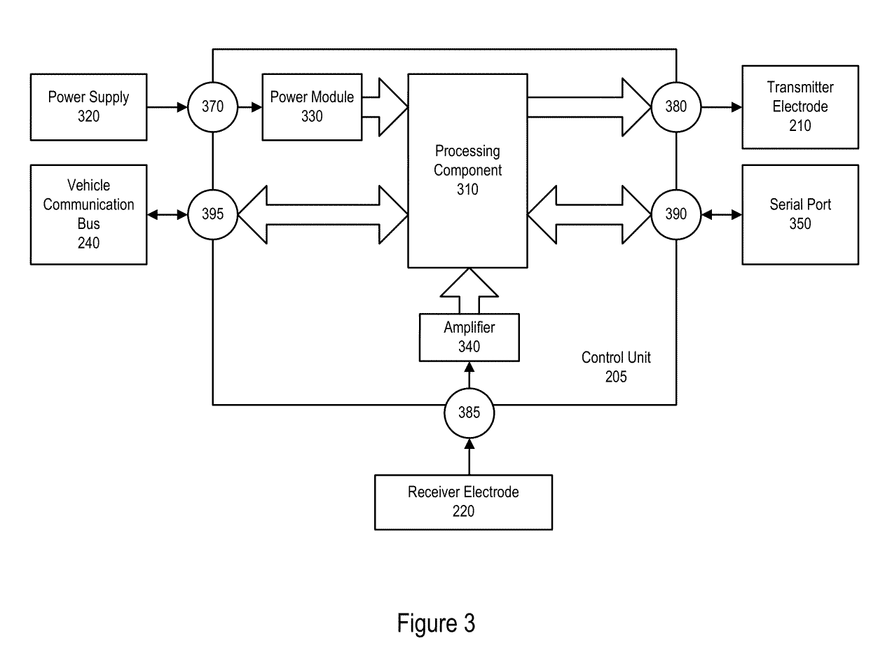

FIG. 3 is a block diagram of an example control unit 205 that may be included with the operator recognition system 200. The control unit 205 may be configured to communicate with one or more of the transmitter electrode 210, the receiver electrode 220, a dashboard control 170 or controller 290 of the dashboard control 170, a power supply 320, and a serial port 350.

The control unit 205 may be located near or adjacent to the dashboard control 170 of the vehicle. For example, the control unit 205 may be positioned behind the dashboard control 170 of the vehicle. Positioning the control unit 205 near the receiver electrode 220 may be useful to limit a connection line between the control unit 205 and the dashboard control 170. A shorter connection line may reduce or eliminate interference that may exist with a long wire connection between the control unit 205 and the dashboard control 170. In other systems, the control unit 205 may be positioned in various other locations throughout the passenger compartment 100. The control unit 205 of the operator recognition system 200 may control one or more electrical systems or subsystems in the passenger compartment 100. The control unit 205 may, for example, include an electronic control unit, such as an electronic/engine control module (“ECM”), a powertrain control module (“PCM”), transmission control module (“TCM”), a brake control module (“BCM” or “EBCM”), a central control module (“CCM”), a central timing module (“CTM”), a general electronic module (“GEM”), a body control module (“BCM”), a suspension control module (“SCM”), or other control module. The control unit 205 may instruct, control, override, or direct one or more controllers of components in a passenger compartment 100, such as controller 290 of the dashboard control 170.

The control unit 205 may be powered by power from a power supply 320. The control unit 205 may communicate with a power supply 320 through a control unit interface 370. The power supply 320 may be a battery, motor, or other power source, such as a battery for the passenger compartment 100. The power supply 320 may provide a voltage, current, or other power source to the control unit 205. The power supply 320 may provide or supply various levels of power to the control unit 205. For example, the power supply 320 may provide or supply 12 volts (“V”) to the control unit 205 by or through the interface 370.

The control unit 205 may transmit the power to, or receive the power at, a power module 330 within the control unit 205. The power module 330 may transform, reduce, or allocate a portion of the power provided by the power supply 320 to a processing component 310 of the control unit. For example, the power module 330 may step-down 12 V provided by the power supply 320 to 5 V or less to be transmitted to, and used to power, the processing component 310.

The processing component 310 may include one or more central processing units (CPUs), general processors, digital signal processors, application specific integrated circuits, field programmable gate arrays, servers, networks, digital circuits, analog circuits, combinations thereof, or other now known or later developed devices for analyzing and processing data. The processing component 310 may implement a software program, such as code generated manually, and/or may perform functions or logic. The processing component 310 may perform and control one or more operations of the control unit 205.

The processing component 310 of the control unit 205 may be connected to the transmitter electrode 210, such as through an interface 380 and a communication line 250. The processing component 310 may be configured instruct the control unit 205 to send the transmit signal, voltage, or current to the transmitter electrode 210. For example, the processing component 310 may be configured to provide a pulsed transmit signal to the transmitter electrode 210 upon a receipt of an indication of an input at the dashboard control 170 through the vehicle communication bus 240.

The processing component 310 of the control unit 205 may additionally or alternatively be connected to the vehicle communication bus 240, such as through an interface 395. The processing component 310 of the control unit 205 may be configured to monitor and receive inputs from the components of the passenger compartment 100 through the vehicle communication bus 240 and the interface 395. The processing component 310 of the control unit 205 may be configured to deliver or transmit signals, commands, or otherwise control one or more functions of the components of the passenger compartment 100 through the vehicle communication bus 240. For example, the processing component 310 may instruct the controller 290 of the dashboard control 170 to provide different functions in response to an input based on what type of operator is detected by the control unit 205.

The processing component 310 of the control unit 205 may additionally or alternatively be configured to monitor, receive, or detect a receive signal at the receiver electrode 220, such as by or through the interface 385 and communication line 260. The control unit 205 may or may not include an amplifier 340, which may amplify a received signal or current from the receiver electrode 220 before the signal or current is transmitted to, or received by, the processing component 310.

The processing component 310 of the control unit 205 may additionally or alternatively communication with a serial port 350, such as through an interface 390. The serial port 350 may be used to connect the control unit 205 to one or more additional electric components. An example of the serial port 350 may be a PC RS-232 port, which may operate according to an RS-232 serial interface standard. The serial port 350 may include a connector, such as a DE-9 connector. The control unit 205 may communicate with one or more other devices using the serial port 350, such as with a computer operating monitoring software or programs. The control unit 205 may, for example, transmit data regarding operation of the operator recognition system to a monitoring software for data collection and monitoring purposes. Other operator recognition systems 200 may not include a serial port 350.

The control unit 205 may additionally include or access memory. The memory may store instructions, code, or logic which the control unit 205 may implement to perform various functions. The memory may be a main memory, a static memory, or a dynamic memory. The memory may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. The term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

In some systems, the memory may include a cache or random access memory for the processing component 310. In alternative embodiments, the memory may be separate from the processing component 310, such as a cache memory of a processor, the system memory, or other memory. The memory may be an external storage device or database for storing data, such as a hard drive, compact disc (“CD”), digital video disc (“DVD”), memory card, memory stick, floppy disc, universal serial bus (“USB”) memory device, or any other device operative to store data.

The memory may be operable to store instructions executable by the processing component 310. The functions and blocks illustrated in the figures or described herein may be performed by the programmed processing component 310 executing instructions stored in the memory. The functions and blocks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The control unit 205 may additionally or alternatively include an analog-to-digital converter. The analog-to-digital converter may be configured to receive an analog signal, such as a signal from the controller 290 over the vehicle communication bus 240, and convert the analog signal to a digital signal for processing by the processing component 310. The control unit 205 may include additional, fewer, or different components.

Other variations are possible.

The control unit 205 may be configured to determine an operator providing an input to a dashboard control 170. The control unit 205 may be configured to perform, or instruct a component to perform, a function in response to the input based on a determination of the operator.

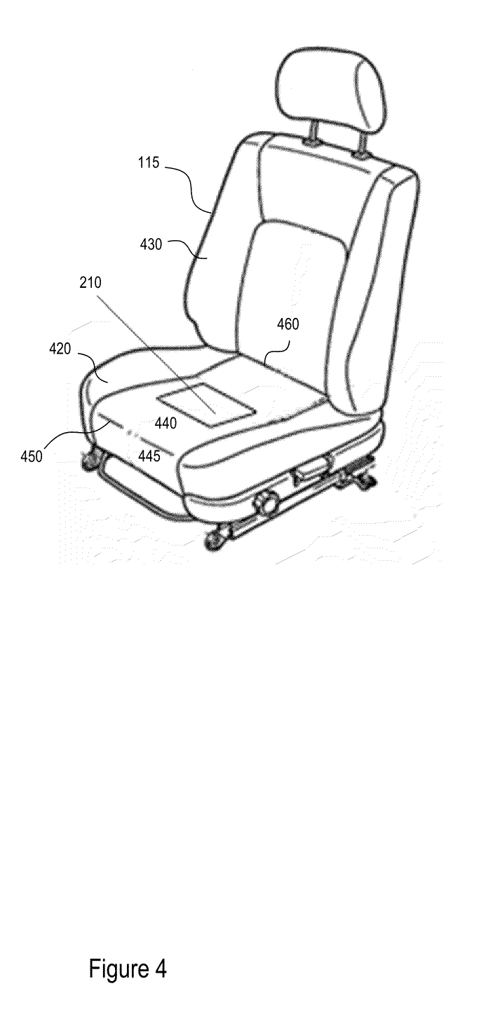

The transmitter electrode 210 may be positioned in various places within or near the passenger seat 115. FIG. 4 is a perspective diagram of a passenger seat 115 with a transmitter electrode 210.

The passenger seat 115 may include a back cushion 430. The passenger seat 115 may include a seat cushion 420. The seat cushion 420 may include a top surface 440, a front surface 445, a front edge 450 joining the top surface 440 and the front surface 445, and a back edge 460 where the back cushion 430 meets the seat cushion 420.

The transmitter electrode 210 may be positioned within, or attached to a surface of, the seat cushion 420. For example, the transmitter electrode 210 may be built into a passenger seat 115, on top of a cushioning of the seat cushion 420. The transmitter electrode 210 may be covered by a covering of the seat cushion 420, or may be positioned above a covering of the seat cushion 420. The transmitter electrode 210 may additionally or alternatively be positioned a distance below a surface of the seat cushion 420. For example the transmitter electrode 210 may be positioned within a foam layer of the seat cushion 420, and may be covered by a layer of cloth, leather, or other fabric which may be the top surface 440 of the seat cushion 420. Other variations are possible.

The transmitter electrode 210 may be positioned near a middle of the seat cushion 420, such as along or near a top surface 420 approximately an equal distance from the front edge 450 and the back edge 460 of the seat cushion 420. Additionally or alternatively, the transmitter electrode 210 maybe positioned closer to a front edge 450 of the seat cushion 420. Positioning the transmitter electrode 410 near the front edge 450 of the seat cushion 420 relative to the back edge 460 of the seat cushion 420 may increase a likelihood that the transmit signal from the transmitting electrode 210 is passed to a passenger 125 leaning forward in the passenger seat 115.

Additionally or alternatively, the transmitter electrode 210 may be configured such that part of the transmitter electrode 210 may be positioned near a top surface 440 of the seat cushion 420, and part of the transmitter electrode 210 may be positioned near a front surface 445 of the seat cushion 420. The transmitter electrode 210 may be positioned to reach most areas of a seat cushion 420. The transmitter electrode 210 may be positioned to reach those areas that a passenger 125 may be most likely to be in contact with in the passenger seat 115.

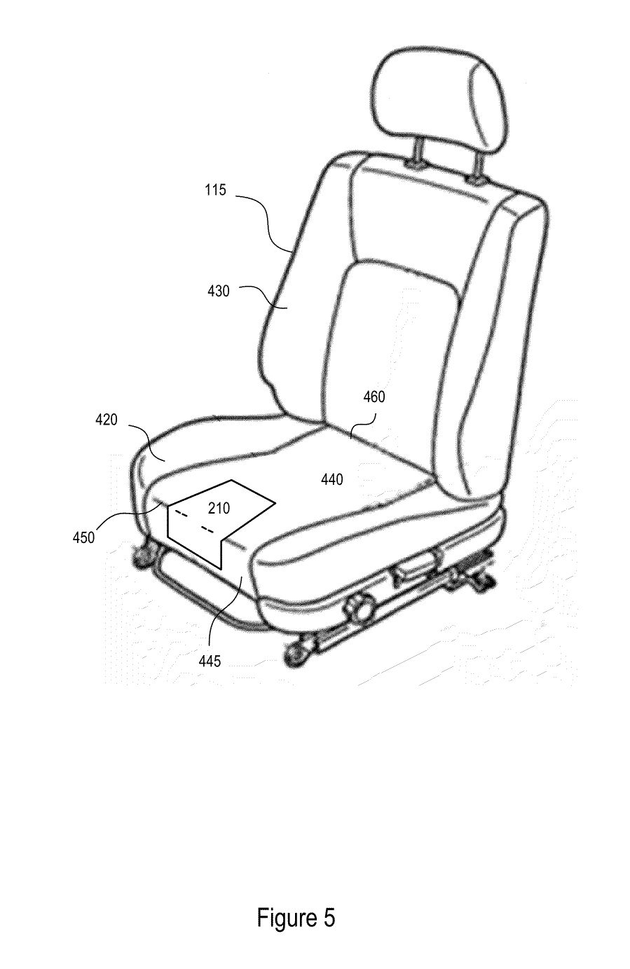

FIG. 5 is a perspective diagram of a passenger seat 115 with a transmitter electrode 210 with a portion of the transmitter electrode 210 positioned near the top surface 440 of the seat cushion 420 and a portion of the transmitter electrode 210 positioned near the front surface 445. A configuration where the transmitter electrode 210 is positioned overlapping a front edge 450 of the seat cushion 420 may further increase a likelihood that the current or signal from the transmitting electrode 210 is received by a passenger 125 when a passenger 125 is leaning forward in the passenger seat 115, such as when a passenger 125 is leaning forward to adjust a dial on a dashboard control. In this configuration, a calf or portion of the leg of the passenger 125 may contact the transmitting electrode 210.

Additionally or alternatively, the transmitter electrode 210 may be positioned within or on various other parts of the passenger seat 115. For example, the transmitter electrode 210 may be positioned within part of the back cushion 430 of the passenger seat 115, along a side of the passenger seat 115 or near the back edge 460 of the passenger seat 115. In some systems, more than one transmitter electrode 210 may be positioned within the passenger seat 115, such as where a first transmitter electrode 210 is positioned in a seat cushion 420 of the passenger seat 115 and a second transmitter electrode 210 is positioned in a back cushion 430 of the passenger seat 115. Various other configurations are possible.

The transmitter electrode 210 may have various shapes or dimensions. For example, the transmitter electrode 210 may be substantially square or rectangular. In other variations, the transmitter electrode 210 may be circular, oval, rounded, rectangular, triangular, pentagonal, hexagonal, octagonal, or any other regular or irregular shape or combination of shapes.

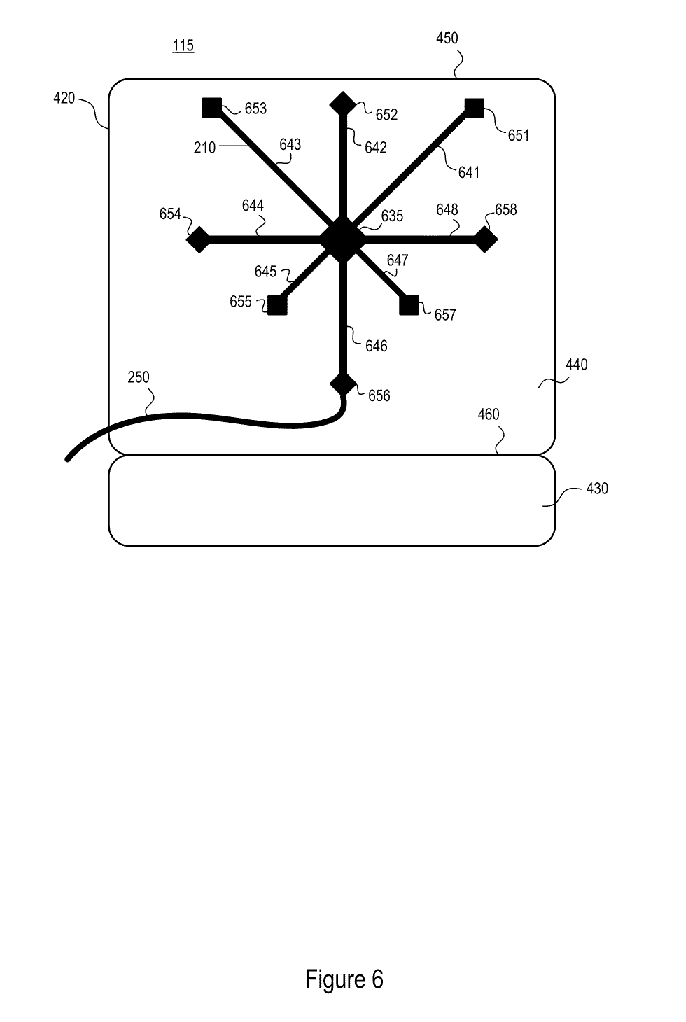

FIG. 6 is a top view of a passenger seat 115 with an alternative transmitter electrode 210. The transmitter electrode 210 may include one or more branches 641-648. The branches or arms 641-648 may connect with each other and/or may extend from a central node 635. The central node 635 may be various shapes and sizes. As an example, the central node 635 may be a diamond or square shape with sides that may be approximately 2 inches long. One or more arm 641-648 may include extended node 651-658. The nodes 651-658 may include a larger surface area than a width of the branch, and may be various shapes and sizes. One or more arms, such as arms 641-643, may extend directly, indirectly, or partially from the central node 635 toward a front edge 450 of the passenger seat 115. One or more arms, such as arms 643-645, may extend directly, indirectly, or partially from the central node toward a side edge of the passenger seat 115. One or more arms, such as arms 645-647, may extend directly, indirectly, or partially from the central node toward a back edge 460 of the passenger seat 115. The arms 641-648 may be positioned parallel with each other (such as arms 641 and 645), perpendicular to each other (such as arms 641 and 643), or at various other angles or positions. The branches 641-648 and nodes 651-658 of the transmitter electrode 210 may cover a wide surface area of the top surface 440 of the seat cushion 420 without requiring a large amount of material for the transmitter electrode 210. The branches 641-648 and nodes 651-658 of the transmitter electrode 210 may spread out across the seat cushion 420 to improve a connection or communication between the transmitter electrode and a passenger 125 in the passenger seat 115, regardless of a sitting position or posture of the passenger 125.

One or more branches 641-648 or nodes 651-658 of the transmitter electrode 210 may extend over the front edge 450 of the seat cushion 420, or may be positioned or placed near a front surface 445 of the seat cushion 420. One or more branches 641-648 or nodes 651-658 of the transmitter electrode 210 may be positioned with the back cushion 430 of the passenger seat 115.

The transmitter electrode 210 may be in communication with a communication line 250. The electrical communication line 250 may be used to connect the transmitter electrode 210 to a control unit 230 of the operator recognition system 200. The control unit 205 may provide a transmit signal to the transmitter electrode 210 through the communication line 250. Various other shapes, configurations, and placements of transmitter electrodes 210 are possible.

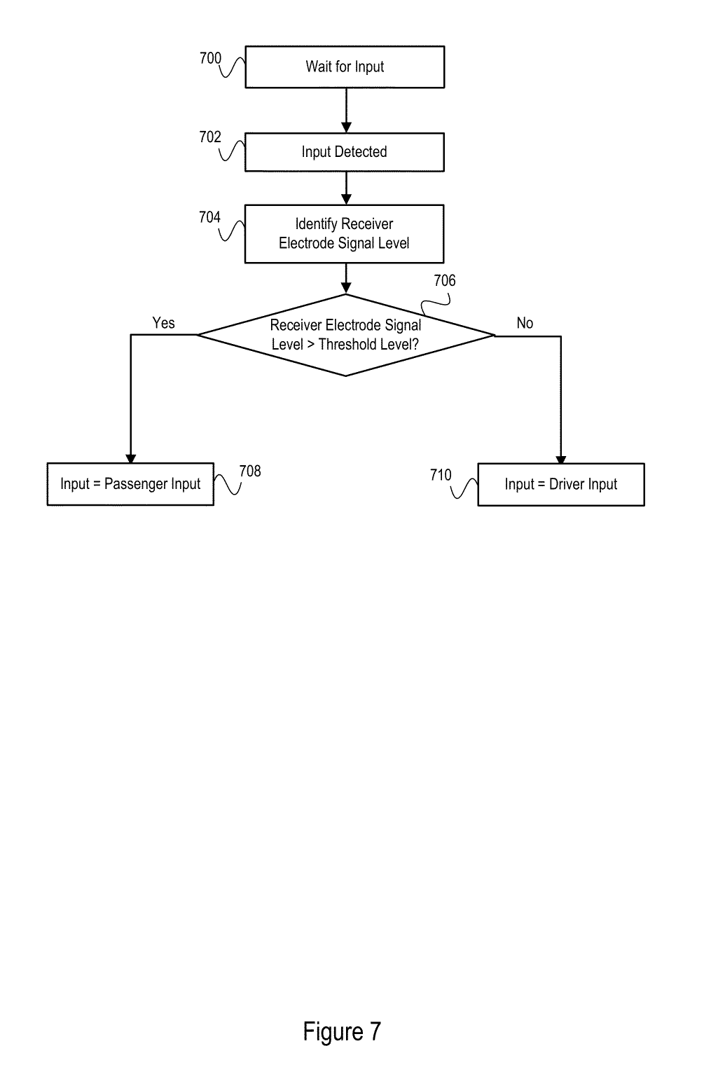

FIG. 7 is a flow diagram of an example method of using the operator recognition system 200 to detect an operator providing an input to a component of the passenger compartment 100.

The method may begin at block 700. The control unit 205 may monitor a dashboard control 170 and wait for an input. The control unit 205 may additionally or alternatively monitor the receiver electrode 220 of the dashboard control 170. At block 702, the control unit 205 may detect an input of the dashboard control 170. The control unit 205 may detect the input in various ways, such as by receiving an indication of the input from a controller of the dashboard control 170 through the vehicle communication bus 240. The control unit 205 may additionally or alternatively provide a transmit signal or current to the transmitter electrode 210 before, during, or after detecting the input.

At block 704, the control unit 205 may detect or identify a receive signal level of receiver electrode 220. The receiver electrode 220 may be an electrode associated with or in communication with the dashboard control 170. The control unit 205 may detect the receive signal level at the receiver electrode 220 through a communication line 260.

At block 706, the control unit 205 may compare the signal level at the receiver electrode 220 to a threshold level. When the receive signal level of the receiver electrode 220 is greater than the threshold level the method may proceed to block 708.

At block 708, the control unit 205 may determine that the input is a passenger input provided by the passenger 125. The passenger 125 may be in communication with the transmitter electrode 210 and may receive the transmit signal provided to the transmitter electrode 210 by the control unit 205. The passenger 125 may transfer the transmit signal to the receiver electrode 220 when initiating or providing the input to the dashboard control 170, creating a receive signal at the receiver electrode 220. Accordingly, the control unit 205 may determine that the input is a passenger input when the signal level of the receiver electrode 220 is greater than the threshold value.

Returning to block 706, if the control unit 205 determines that the signal level at the receiver electrode 220 is not greater than the threshold left, the method may proceed to block 710. At block 710, the control unit 205 may determine that the input is a driver input provided by the driver 120. The driver 120 may not be in communication with the transmitter electrode 210 and may not receive any signal from the transmitter electrode 210. The driver 120 may thus not transfer a receive signal to the receiver electrode 220 when providing the input to the dashboard control 170. Accordingly, the control unit 205 may determine that the input is a driver input when the signal level of the receiver electrode 220 is not greater than the threshold value.

The method of FIG. 7 may be implemented as logic or code which may be run or performed by the processing component 310 of the control unit 205. In some variations, the blocks or logic of FIG. 7 may include additional, fewer, or different blocks or functions. In some variations, one or more blocks may perform different functions, or one or more blocks may be combined into fewer functions or determinations. In some variations, one or more blocks or functions may be performed in a different order or at the same time.

In some variations, at blocks 704 and 706, the method may compare an identified receiver electrode signal to a threshold level multiple times. For example, the operator recognition system 200 may provide multiple pulsed signals to the transmitter electrode 210 in succession, and may detect the receiver electrode 220 signal level when each of the pulsed signals are sent to the transmitter electrode 210. In some of these systems, the method may proceed to block 708 when the signal has been detected at the receiver electrode 220 a number of times, or when the signal level at the receiver electrode 220 has been greater than a threshold level for a determined period of time. Otherwise, the method may move to block 710. In some variations, the method of FIG. 7 may be performed only when the passenger compartment 100 is operating in a determined state. For example, the method of FIG. 7 may be performed when the passenger compartment 100 is in a “Drive” or “Forward” mode, but may not be performed when the passenger compartment 100 is in a “Park” or stationary mode. Various other examples and variations of logic are possible.

The method or logic of FIG. 7 may be implemented or used to determine an operator that provides an input to a dashboard control 170. Once a determination is made as to the operator providing the input, the control unit 205 may perform various actions or initiate different functions according to the determination.

By controlling a response to an input based on the determination of the inputting operator, the control unit 205 may provide, enable, or facilitate a smart implementation of user controls for the passenger compartment 100, and may provide an ease of use for the determined operator. For example, the operator recognition system 200 may be used or implemented to create a more stream-lined dashboard control 170, where otherwise separate inputs, controls, or buttons for a driver 120 and passenger 125 may be consolidated into one input, control, or button. The one input, control, or button may be used to elicit different functions based on who the control unit 205 recognizes is providing the input.

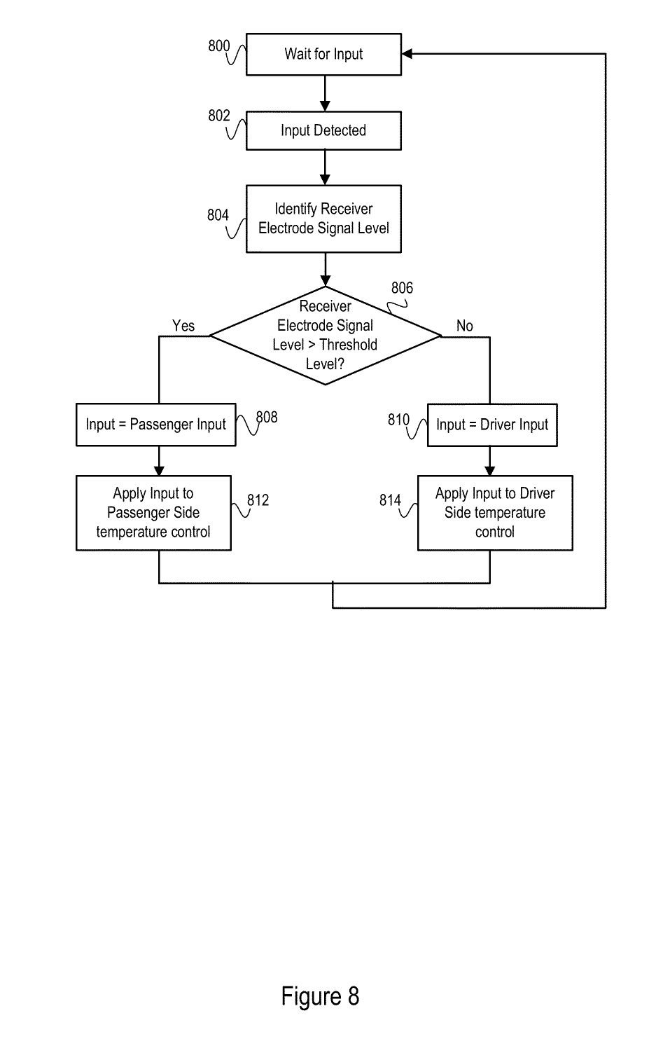

FIG. 8 is an example of a method using the operator recognition system 200 to detect an operator providing an input to a temperature system of the passenger compartment 100 and controlling the response of the temperature system based on the detected operator. The temperature system may include a multiple control system, such as a dual-climate temperature system with a passenger side temperature control to control a temperature on a passenger side of the passenger compartment 100, and a driver side temperature control to control a temperature on a driver side of the passenger compartment 100. Other variations are possible.

Blocks 800-810 of the method of FIG. 8 may be similar to, the same as, or otherwise resemble blocks 700-710 of the method of FIG. 7. At block 800, the control unit 205 may wait for an input at the temperature system.

At block 802, the control unit 205 may detect an input at the temperature system. The input may be, for example, a turn of a knob which may be intended to change the temperature of a portion of the passenger compartment 100. The input may additionally or alternatively be a push of a button, activation of a touch screen input, movement of a control slide, or various other inputs.

At block 804, the control unit 205 may identify a signal level of the receiver electrode 220 associated with the dashboard control 170. At block 806, the signal level of the receiver electrode 220 may be compared with a threshold level.

At block 806, if the signal level of the receiver electrode 220 is greater than the threshold level, the method may proceed to block 808. At block 808, the control unit 205 may determine the input as a passenger input.

At block 812, the control unit 205 may apply, or may instruct the temperature system to apply, the input to a passenger side temperature control. For example, where the input is a turn of a knob indicative of turning down a temperature, the control unit 205 may initiate, or may instruct the temperature system to initiate, an air conditioning unit on a passenger side of the passenger compartment 100. Alternatively, where the input is a turn of a knob indicative of turning up a temperature, the control unit 205 may initiate, or may instruct the temperature system to initiate, a heating unit on a passenger side of the passenger compartment 100. Other variations are possible.

Returning to block 806, if the signal level of the receiver electrode 220 is not greater than the threshold level, the method may proceed to block 810. At block 810, the control unit 205 may determine the input as a driver input.

At block 814, the control unit 205 may apply, or may instruct the temperature system to apply, the input to a driver side temperature control. For example, where the input is a turn of a knob indicative of turning down a temperature, the control unit 205 may initiate, or may instruct the temperature system to initiate, an air conditioning unit on a driver side of the passenger compartment 100. Alternatively, where the input is a turn of a knob indicative of turning up a temperature, the control unit 205 may initiate, or may instruct the temperature system to initiate, a heating unit on a driver side of the passenger compartment 100. Other variations are possible.

After blocks 812 or 814, the method may return to block 800 and await the next input at the temperature system. The method of FIG. 8 may be applied to various other components to provide different functions based on a determination of the operator that provided an input to a component of the passenger compartment 100. The method of FIG. 8 may be applied with the passenger compartment 100 to reduce a number of controls that may be needed to perform functions for a driver 120 and passenger 125.

The method of FIG. 8 may be implemented as logic or code which may be run by the processing component 310 of the control unit 205. In some variations, the logic of FIG. 8 may include additional, fewer, or different blocks. In some variations, one or more blocks may perform different functions, or one or more blocks may be combined into fewer functions or determinations. In some variations, one or more blocks or functions may be performed in a different order or at the same time. In some variations, the method of FIG. 8 may be performed only when the passenger compartment 100 is operating in a determined state.

In some variations, at blocks 804 and 806, the method may compare an identified receiver electrode signal to a threshold level multiple times. For example, the operator recognition system 200 may provide multiple pulsed signals to the transmitter electrode 210 in succession, and may detect the receiver electrode 220 signal level when each of the pulsed signals are sent to the transmitter electrode 210. In some of these systems, the method may proceed to block 808 when the signal has been detected at the receiver electrode 220 a number of times, or when the signal level at the receiver electrode 220 has been greater than a threshold level for a determined period of time. Otherwise, the method may move to block 810. Various other examples and logic may be implemented or performed by a control unit 205 to enable or facilitate a smart implementation of user controls for the passenger compartment 100, and provide an ease of use for the determined operator are possible.

By controlling a response to an input based on the determination, interpretation, or recognition of the inputting operator, the control unit 205 may enhance safety and security of the passenger compartment 100. The control unit 205 may disable or inactivate some functions or dashboard controls 170 when the driver 120 provides the input. For example, the control unit 205 may provide functionality associated with an input on a touch-screen interface of an entertainment system dashboard control 170 when the control unit 205 determines that the passenger 125 provided the input to the dashboard control 170. The control unit 205 may disable the touch-screen interface, or provide a limited functionality associated with an input to the entertainment system dashboard control 170, when the control unit 205 determines that the driver 120 provided the input to the dashboard control 170.

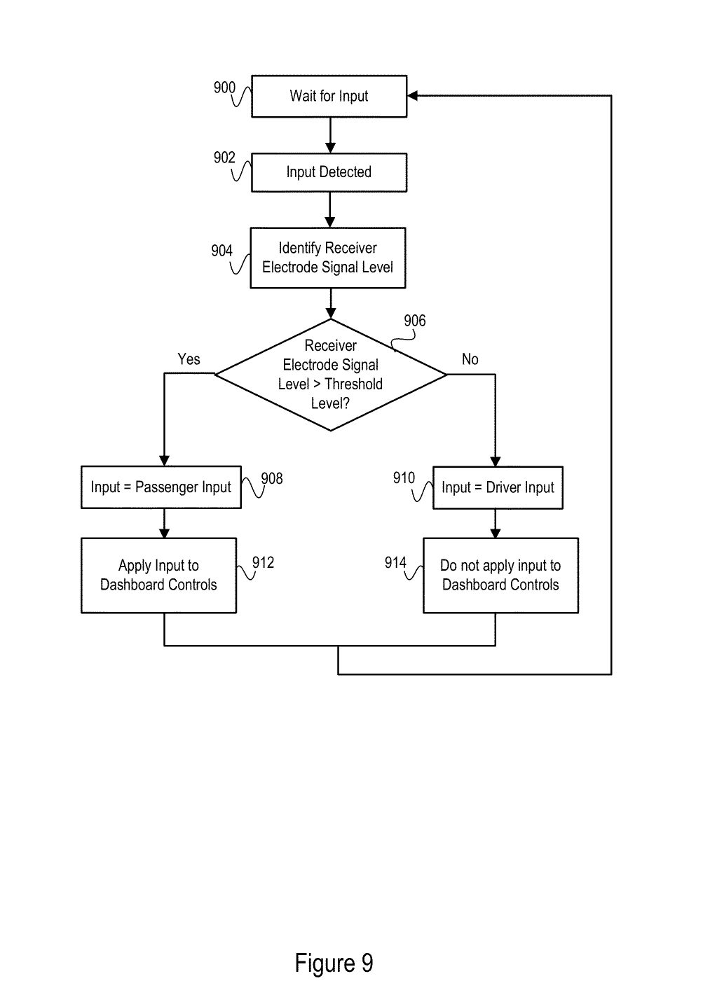

FIG. 9 is an example of a method using the operator recognition system 200 to detect an operator initiating or providing an input to a dashboard control of the passenger compartment 100 and controlling the accessibility and functionality of the dashboard control based on the detected operator. The method of FIG. 9 may be incorporated or performed when an operator provides an input to perform a non-permitted function, such as operation of a dashboard control when a passenger compartment 100 is moving. Other variations and examples are possible.

Blocks 900-910 of the method of FIG. 9 may be similar to, the same as, or otherwise resemble blocks 700-710 of the method of FIG. 7. At block 900, the control unit 205 may wait for an input at the dashboard control.

At block 902, the control unit 205 may detect an input at the dashboard control. The input may be, for example, a touch of a touch screen that may be intended to control an entertainment system, or to focus a map or directions provided by a GPS system. The input may additionally or alternatively be a turn of a knob, a push of a button, movement of a control slide, or various other inputs.

At block 904, the control unit 205 may identify a signal level of the receiver electrode 220 associated with the dashboard control. At block 906, the signal level of the receiver electrode 220 may be compared with a threshold level.

At block 906, if the signal level of the receiver electrode 220 is greater than the threshold level, the method may proceed to block 908. At block 908, the control unit 205 may recognize the input as a passenger input.

At block 912, the control unit 205 may apply, or may instruct the controller 290 of the dashboard control 170 to apply, the input to the dashboard controls. For example, where the input is a touch on a touch screen over an input control to change a view of a map being displayed with or through a GPS system, the control unit 205 may perform or instruct the GPS system to change the map view in accordance with the input. As another example, where the input is a turn of a knob indicative of turning down a volume of an audio of the entertainment system, the control unit 205 may perform or instruct the entertainment system to turn down the audio on the entertainment system. As another example, where the input is push of a button to change a track being played over the vehicle entertainment system, the control unit 205 may perform or instruct the entertainment system to change the track being played in accordance with the input. Other variations are possible. Returning to block 906, if the signal level of the receiver electrode 220 is not greater than the threshold level, the method may proceed to block 910. At block 910, the control unit 205 may determine, interpret, or recognize the input as a driver input.

The control unit 205 may be programmed to disable or disallow inputs to the dashboard controls from a driver 120. As such, at block 914, the control unit 205 may not apply the input to the dashboard control. The control unit 205 may additionally or alternatively disable one or more dashboard controls. The control unit 205 may not allow a driver input to be performed by the dashboard control.

After blocks 912 or 914, the method may return to block 900 and await the next input at the dashboard control. The method of FIG. 9 may be applied to various other systems or components to provide different responses based on a determination of the operator that initiated or provided an input to a component of the passenger compartment 100.

The method of FIG. 9 may be implemented as logic or code which may be run or performed by the processing component 310 of the control unit 205. In some variations, the blocks or logic of FIG. 9 may include additional, fewer, or different blocks or functions. In some variations, one or more blocks may perform different functions, or one or more blocks may be combined into fewer functions or determinations. In some variations, one or more blocks or functions may be performed in a different order or at the same time.

For example, in some variations, the method of FIG. 9 may include a block between block 910 and block 914 which may be used to determine whether the input is for a permitted function or a non-permitted function. For example, the control unit 205 may be configured to allow a driver 120 to input and manipulate some dashboard controls (such as changing a volume on an entertainment system) as permitted functions, while disallowing other dashboard controls (such as a manipulation of a map on a GPS system) as non-permitted functions. Where the control unit 205 determines that the driver input relates to a permitted function, the method may proceed to block 912. Where the control unit determines that the driver input is a non-permitted function, the method may proceed to block 914.

In some variations, the method of FIG. 9 may be performed only when the passenger compartment 100 is operating in a determined state. For example, the method of FIG. 9 may be performed when the passenger compartment 100 is in a “Drive” or “Forward” mode, but may not be performed when the passenger compartment 100 is in a “Park” or stationary mode. In some variations, the method of FIG. 9 may include a decision block where the control unit 205 may determine the mode of operation of the passenger compartment 100. If the passenger compartment 100 in the “Drive” or “Forward” mode, the method may proceed as described. If the passenger compartment 100 is in the “Park” or stationary mode, the method may apply all inputs to the dashboard controls, regardless of whether the input is a driver input or a passenger input.

In some variations, at blocks 904 and 906, the method may compare an identified receiver electrode signal to a threshold level multiple times. For example, the operator recognition system 200 may provide multiple pulsed signals to the transmitter electrode 210 in succession, and may detect the receiver electrode 220 signal level when each of the pulsed signals are sent to the transmitter electrode 210. In some of these systems, the method may proceed to block 908 when the signal has been detected at the receiver electrode 220 a number of times, or when the signal level at the receiver electrode 220 has been greater than a threshold level for a determined period of time. Otherwise, the method may move to block 910. Various other examples and variations of logic are possible.

The control unit 205 may additionally or alternatively enhance safety and security of the passenger compartment 100 by restricting access to one or more components of a passenger compartment 100 used for controlling a movement of the passenger compartment 100 to the driver 120.

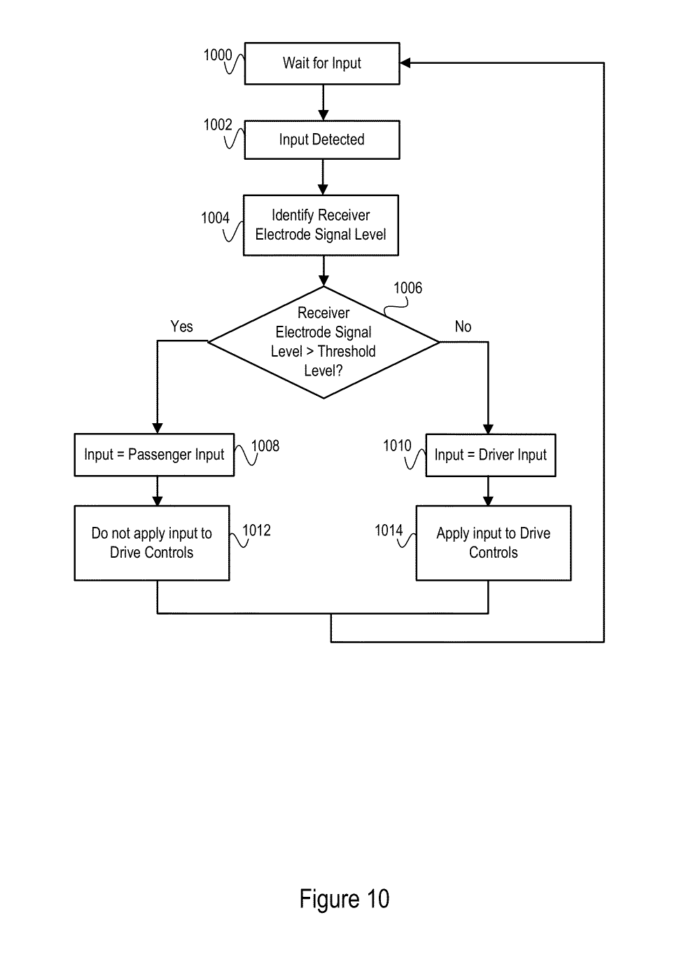

FIG. 10 is an example of a method using the operator recognition system 200 to detect an operator providing an input to a dashboard control 170 of the passenger compartment 100 and controlling the accessibility and functionality of a movement or operation component of the passenger compartment 100. The method of FIG. 10 is described with reference to the gear adjuster 160, but may be applied to any component of the passenger compartment 100 that controls a movement or operation of the passenger compartment 100, such as a steering wheel 150, four-wheel drive engagement switch, headlights, acceleration or power controls, or various other components.

Blocks 1000-1010 of the method of FIG. 10 may be similar to, the same as, or otherwise resemble blocks 700-710 of the method of FIG. 7. At block 1000, the control unit 205 may wait for an input at the gear adjuster 160.

At block 1002, the control unit 205 may detect an input at the gear adjuster 160. The input may be, for example, an activation of a button or a movement of a shifter. The input may additionally or alternatively be a turn of a knob, a movement of a control slide, or various other inputs.

At block 1004, the control unit 205 may identify a signal level of the receiver electrode 220 associated with the gear adjuster 160. At block 1006, the signal level of the receiver electrode 220 may be compared with a threshold level.

At block 1006, if the signal level of the receiver electrode 220 is greater than the threshold level, the method may proceed to block 1008. At block 1008, the control unit 205 may recognize the input as a passenger input.

The control unit 205 may be programmed to disable or disallow inputs to the gear adjuster 160 from a passenger 125. As such, at block 1012, the control unit 205 may not apply the input to the gear adjuster 160. The control unit 205 may additionally or alternatively disable or deactivate one or more gear adjuster functions. The control unit 205 may not allow a passenger input to be performed by the gear adjuster 160.

Returning to block 1006, if the signal level of the receiver electrode 220 is not greater than the threshold level, the method may proceed to block 1010. At block 1010, the control unit 205 may recognize the input as a driver input.

At block 1014, the control unit 205 may apply the input to the gear adjuster 160. For example, where the input is a change in mode of operation of the passenger compartment 100, the control unit 205 may change, or instruct a drive control of the vehicle to change, the mode of operation of the passenger compartment 100 in accordance with the input. As another example, where the input is a press of a button to activate a four-wheel drive of a passenger compartment 100, the control unit 205 may activate, or instruct a controller to activate, the four-wheel drive system of the passenger compartment 100. Other variations are possible. After blocks 1012 or 1014, the method may return to block 1000 and await the next input at the gear adjuster 160. The method of FIG. 10 may be applied to various other components to provide different responses based on which operator initiated an input to a component of the passenger compartment 100.

The method of FIG. 10 may operate to control the control unit 205 to only enable functionality associated with an input to a component of the passenger compartment 100 associated with a movement of the passenger compartment 100 when the input is provided or initiated by the driver 120. The control unit 205 may disable or ignore inputs when the control unit 205 detects that the inputs are provided by the passenger 125.

The method of FIG. 10 may be implemented as logic or code which may be run or performed by the processing component 310 of the control unit 205. In some variations, the blocks or logic of FIG. 10 may include additional, fewer, or different blocks or functions. In some variations, one or more blocks may perform different functions, or one or more blocks may be combined into fewer functions or determinations. In some variations, one or more blocks or functions may be performed in a different order or at the same time.

In some variations, the method of FIG. 10 may be performed only when the passenger compartment 100 is operating in a determined state. For example, the method of FIG. 10 may be performed when the passenger compartment 100 is in a “Drive” or “Forward” mode, but may not be performed when the passenger compartment 100 is in a “Park” or stationary mode. In some variations, the method of FIG. 10 may include a decision block where the control unit 205 may determine the mode of operation of the passenger compartment 100.

In some variations, at blocks 1004 and 1006, the method may compare an identified receiver electrode signal to a threshold level multiple times. For example, the operator recognition system 200 may provide multiple pulsed signals to the transmitter electrode 210 in succession, and may detect the receiver electrode 220 signal level when each of the pulsed signals are sent to the transmitter electrode 210. In some of these systems, the method may proceed to block 1008 when the signal has been detected at the receiver electrode 220 a number of times, or when the signal level at the receiver electrode 220 has been greater than a threshold level for a determined period of time. Otherwise, the method may move to block 1010. Various other examples and variations of logic that may be implemented or performed by a control unit 205 to enhance safety and security of the passenger compartment 100 are possible.

In some systems, the operator recognition system 200 may execute instructions, code, or logic using one or more processors or processing components, such as processing component 310, to perform one or more of the methods described. In other systems, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. Accordingly, the present system encompasses software, firmware, and hardware implementations

In some systems, the operator recognition system 200 may include a transmitter electrode 210 positioned with a driver seat 110, and may not include an electrode positioned with the passenger seat 115. In some of these systems, the detection of an operator providing an input by the control unit 205 may be reversed, such that when a receive signal is detected at the receiver electrode 220, the control unit 205 may recognize the input as being provided by the driver 120. In contrast, when the receive signal is not detected at the receiver electrode 220 after the transmit signal is provided to the transmitter electrode 210, the control unit 205 may recognize the input as being provided by the passenger 125.

In some systems, the operator recognition system 200 may reverse the position of the transmitter electrode 210 and the receiver electrode 220. For example, the transmitter electrode 210 may be positioned with the dashboard control 170, and the receiver electrode 220 may be positioned within the passenger seat 115. The control unit 205 may provide a transmit signal to the transmitter electrode 210 at the dashboard control 170, and may detect a receive signal at the receiver electrode 220 within the passenger seat 115. Other variations and positions are possible.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

While the above described methods and systems may refer to a comparison and/or determination as to whether one element is greater than or equal to a second element, in some embodiments one or more of these comparisons may be replaced by a comparison and/or determination as to whether one element is greater than a second element. Similarly, comparisons and/or determinations described as being “greater than” may also be replaced with “greater than or equal to.” While the above described methods may refer to a comparison and/or determination as to whether one element is less than or equal to a second element, in some embodiments one or more of these comparisons may be replaced by a comparison and/or determination as to whether one element is less than a second element. Similarly, comparisons and/or determinations described as being “less than” may also be replaced with “less than or equal to.” Comparisons and/or determinations made which require an element to “exceed” a second element may be replaced by comparisons and/or determinations which require an element to “exceed or equal” a second element, and vice versa.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A vehicular control system, comprising:
a receiver electrode for an input device;
a control unit in communication with the receiver electrode, the control unit configured to:
determine that an input is received at the input device;
provide a transmit signal to a passenger seat transmitter electrode or a driver seat transmitter electrode, but not both;
detect a receive signal arising from the transmit signal at the receiver electrode; and
determine which of a passenger in a passenger seat or a driver in a driver seat caused the input based on whether the receive signal is detected at the receiver electrode.

2. The vehicular control system of claim 1, where the control unit is configured to apply the input to the input device when the control unit determines the input was caused by the passenger in the passenger seat; and
where the control unit is configured to not apply the input to the input device when the control unit determines the input was caused by the driver in the driver seat.

3. The vehicular control system of claim 1, where the control unit determines that the input was caused by the passenger in the passenger seat when the control unit provides the transmit signal to the passenger seat transmitter electrode and detects the receive signal.

4. The vehicular control system of claim 1, where the control unit determines that the input was caused by the driver in the driver seat when the control unit provides the transmit signal to the passenger seat transmitter electrode and does not detect the receive signal after providing the transmit signal.

5. The vehicular control system of claim 1, where the input device is a temperature control, and where the input corresponds to an adjustment of a temperature.

6. The vehicular control system of claim 5, where the control unit is configured to apply the input to adjust a passenger-side temperature when the control unit determines the input was caused by the passenger in the passenger seat; and
where the control unit is configured to apply the input to adjust a driver-side temperature when the control unit determines the input was caused by the driver in the driver seat.

7. The vehicular control system of claim 1, where the control unit is configured to provide the transmit signal to the passenger seat transmitter electrode and not the driver seat transmitter electrode.

8. The vehicular control system of claim 1, where the transmitter electrode comprises a central node, a first arm extending from the central node towards a front edge of the passenger seat and a second arm extending from the central node towards a back edge of the passenger seat.

9. A method of controlling a function, comprising:
detecting an input provided to an input device, the input device including a receiver electrode;
providing, when the input is detected, a transmit signal to a transmitter electrode of a passenger seat or of a driver seat, but not both;
monitoring the receiver electrode for a receive signal arising from the transmit signal; and
determining an input type of the detected input based on whether the receive signal is detected at the receiver electrode after the transmit signal is provided to the transmitter electrode.

10. The method of claim 9, further comprising performing a function based on the determined input type.

11. The method of claim 9, where the input type is a first input type when the receive signal is detected at the receiver electrode after the transmit signal is provided to the transmitter electrode; and
where the input type is a second input type when the signal is not detected at the receiver electrode after the transmit signal is provided to the transmitter electrode.

12. The method of claim 11, where the input device is a dashboard control, the method further comprising:
applying the input to the dashboard control when the input type is the first input type; and
not applying the input to the dashboard control when the input type is the second input type.

13. The method of claim 9, comprising providing the transmit signal to the transmitter electrode of the passenger seat and not the driver seat.

14. The method of claim 9, comprising providing the transmit signal to the transmitter electrode of the driver seat and not the passenger seat.

15. An operator recognition system, comprising:
a driver seat;
a passenger seat;
a transmitter electrode located in the driver seat or in the passenger seat, but not both;
a dashboard input device including a receiver electrode and a dashboard controller, the dashboard input device configured to receive an input from a user;
a control unit in communication with the transmitter electrode, receiver electrode, and dashboard controller, the control unit configured to:
receive an indication of the input from the dashboard controller;
transmit a signal to the transmitter electrode;
monitor a voltage level at the receiver electrode; and
identify the operator providing the input based on the voltage level at the receiver electrode after the signal is transmitted.

16. The operator recognition system of claim 15, where the control unit is configured to transmit the signal to the transmitter electrode when the control unit receives the indication of the input.

17. The operator recognition system of claim 15, where the control unit is configured to compare the voltage level at the receiver electrode after the signal is transmitted to a threshold level.

18. The operator recognition system of claim 17, where the threshold level is greater than an average level of noise at the receiver electrode.

19. The operator recognition system of claim 17, where the control unit identifies the operator as a passenger in the passenger seat when the transmitter electrode is located in the passenger seat and the voltage level at the receiver electrode is above the threshold value, and where the control unit identifies the operator as a driver in the driver seat when the transmitter electrode is located in the passenger seat and the voltage level at the receiver electrode is not above the threshold value.

20. The operator recognition system of claim 19, where the control unit is configured to instruct the dashboard controller to perform a first function in response to the input when the control unit identifies the operator as the passenger, and where the control unit is configured to instruct the dashboard controller to perform a second function in response to the input when the control unit identifies the operator as the driver.

21. The vehicular control system of claim 1, where the control unit is configured to provide the transmit signal to the driver seat transmitter electrode and not the passenger seat transmitter electrode.

22. The operator recognition system of claim 15, where the transmitter electrode is located in the driver seat and not in the passenger seat.

23. The operator recognition system of claim 15, where the transmitter electrode is located in the passenger seat and not in the driver seat.
